(19) United States
(12) Patent Application Publication
(10) Pub. No.: US 2008/0054234 A1
(43) Pub. Date: Mar. 6, 2008

(54) Flame retardative resin composition

(75) Inventors: Kuen-Yuan Hwang, Hsinchu Industrial District (TW); An-Pang Tu, Hsinchu Industrial District (TW); Chih-Fu Chen, Hsinchu Industrial District (TW); Gai-Chi Chen, Hsinchu Industrial District (TW)

Correspondence Address: MORRISON & FOERSTER LLP, 755 PAGE MILL RD, PALO ALTO, CA, 94304-1018, US

(73) Assignee: Chang Chun Plastics Co., Ltd., Taipei (TW)

(21) Appl. No.: 11/894,890

(22) Filed: Aug. 21, 2007

(30) Foreign Application Priority Data
Sep. 4, 2006 (TW) 095132527

(51) Int. Cl. C09K 21/14

(52) U.S. Cl. 252/609

(57) ABSTRACT

A nonflammable resin composition comprises (A) at least an epoxy resin with biphenyl unit or naphthyl unit; (B) at least a phenolic resin used as a hardener, wherein the phenolic resin has a skeleton formed by phenyl rings bonding directly each other without interruption, and is in an amount of 30 to 100% by weight based on total hardeners; and (C) a curing catalyst. The said nonflammable resin has an excellent flame retardancy, a good heat resistance, and an improved moldability and reliability.

### FIELD OF THE INVENTION

The present invention relates to a nonflammable resin composition. In particular, the present invention relates to a nonflammable epoxy resin composition.

### BACKGROUND OF THE INVENTION

Owing to simple processability, high safety, remarkable mechanical functions and chemical properties, epoxy resins have been widely used in many fields, for example, composite materials, forming materials and semiconductor packaging materials. In order to improve the flame retardancy of epoxy resins, we usually use halogen-containing epoxy resins or hardeners together with antimony trioxide or other flame retardants to reach the requirement of UL 94 V-0 for flame retardancy.

However, such an approach has some problems. Antimony trioxide is known as a carcinogen. Bromine-containing substance gives corrosive bromine radicals and hydrogen bromide, as well as highly brominated aromatic compounds that generate severe toxic bromofurans and bromodioxins when burned. As a result, halogen-free non-flammable epoxy resin compositions are consequently developed. For example, hydroxides such as aluminium hydroxide or magnesium hydroxide, or phosphorus-based flame retardants are used in resin compositions. However, a lot of hydroxides are needed to show the flame retardancy, thus increasing viscosity of resin compositions and making molding difficult. Meanwhile, phosphorus-based flame retardants are sensitive to water and hydrolyzed to give crosive phosphoric acid that decreases the reliability of products.

For the sake of environmental protections, it is a trend to use lead-free solder materials in semiconductor packaging. To adapt encapsulating processes to such solder material variations, solder reflow must be carried out at relatively higher temperature. Meanwhile, superior heat resistance must also be maintained in addition to flame retardancy for the epoxy resin compositions used in semiconductor packaging.

U.S. Pat. No. 6,242,110 discloses an epoxy resin composition applied to semiconductor packaging. Such a composition comprises a phenolic resin having biphenyl unit and/or naphthyl unit, and an epoxy resin having biphenyl unit and/or naphthyl unit, thereby allowing the composition to reach UL 94V-0 specifications for flame retardancy in the absence of flame retardants. However, heat resistance of resin composition is not investigated in that patent.

Additionally, U.S. Pat. No. 6,723,452 discloses an epoxy resin composition used in semiconductor packaging, including an epoxy resin possessing biphenyl unit or naphthyl unit, and phenolic resin possessing biphenyl unit or naphthyl unit, which has excellent flame retardancy and solder crack resistance. US Patent Application Publication 2004/0214003 discloses a resin composition, comprising an epoxy resin having biphenyl unit and a phenolic resin having biphenyl unit or phenyl unit used as a hardener, which has good flowability and moldability.

In view of these phenolic resins used as hardeners in the above-mentioned patents, their aromatic (biphenyl, naphthyl, phenyl or the like) units are all bonded with each other through intervenient groups such as alkylene group. It is not taught by these prior arts that phenolic resins having a skeleton formed by phenyl rings bonded directly are used as hardeners of epoxy resins. Although some properties of epoxy resin compositions are improved by these prior arts, an epoxy resin composition with satisfactory flame retardancy, heat resistance, flowability and moldability are not reported yet.

To overcome the above-mentioned problems, the present invention has been completed after the present inventors studied intensively and made improvement.

### SUMMARY OF THE INVENTION

The primary objective of the present invention is to provide a resin composition performing excellent flame retardancy without adding any flame retardant or aluminum hydroxide.

Another objective of the present invention is to provide a resin composition with good heat resistance.

A further objective of the present invention is to provide a resin composition with improved moldability and reliability.

To achieve the above-mentioned and other objectives, a non-flammable resin composition is provided in the present invention, comprising (A) at least an epoxy resin with biphenyl unit or naphthyl unit; (B) at least a phenolic resin used as a hardener, wherein the phenolic resin has a skeleton formed by phenyl rings bonding directly with each other without interruption, and is contained in an amount of 30 to 100% by weight based on total hardeners; and (C) a curing catalyst. The resin composition of the present invention exhibits superior flame retardancy without adding any flame retardant, good heat resistance, and well improved moldability and reliability.

### DETAILED DESCRIPTIONS OF THE PREFERRED EMBODIMENTS

The resin composition according to the present invention comprises (A) at least an epoxy resin with biphenyl unit or naphthyl unit; (B) at least a phenolic resin used as a hardener, wherein the phenolic resin has a skeleton formed by phenyl rings bonding directly with each other without interruption; and (C) a curing catalyst.

The epoxy resin with biphenyl unit or naphthyl unit has preferably a structure respectively represented by formula (I) or (II):

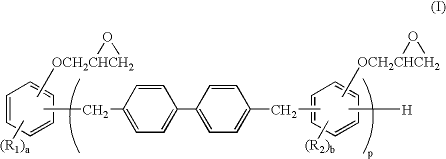

wherein, R₁ and R₂ each independently are alkyl group having 1 to 6 carbon atoms, a is an integer of 0 to 4, b is an integer of 0 to 3, and p is an integer of 1 to 10; and

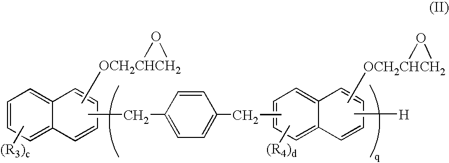

wherein, R₃ and R₄ each independently are alkyl group having 1 to 6 carbon atoms; c is an integer of 0 to 6; d is an integer of 0 to 5; and q is an integer of 1 to 10. Examples of the alkyl group include methyl, ethyl, propyl, isopropyl, butyl, sec-butyl, pentyl, cyclopentyl, hexyl, cyclohexyl, and isomers thereof.

The epoxy resin used in the present resin composition has a skeleton containing biphenyl unit or naphthyl unit. Due to high bonding energy of such units, the present resin composition is hard to be decomposed, and, therefore, has flame retardancy.

The skeleton of the phenolic resin used as a hardener in the present resin composition is formed by phenyl rings, in which two phenyl rings are bonded directly and there are no other groups presented in between two phenyl rings. The phenolic resin has preferably a structure represented by formula (III):

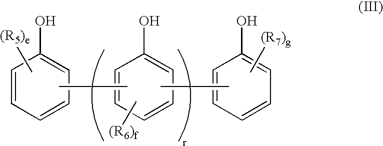

wherein, R₅, R₆, and R₇ each independently are alkyl group having 1 to 6 carbon atoms, e and g each independently are an integer of 0 to 4, f is an integer of 0 to 3, and r is an integer of 1 to 10. Examples of the alkyl group include methyl, ethyl, propyl, isopropyl, butyl, sec-butyl, pentyl, cyclopentyl, hexyl, cyclohexyl, and isomers thereof; methyl, ethyl and propyl are preferable; and methyl is more preferable.

The phenolic resin used in this invention is synthesized by polymerization of phenolic compounds in the presence of oxidants (for example, oxygen or hydrogen peroxide) and coupling catalysts (for example, copper compounds or quarternary ammonium salts).

Compared with novolac resin type hardeners of conventional epoxy resin compositions, in which the aromatic units such as phenyl unit or the like are bound with each other through the alkylene groups in between two aromatic units, the aromatic units (e.g. phenyl unit or the like) of the present phenolic resin are bonded directly with each other without any interruption by other groups inserted between two aromatic units, thus having a property of lower melting viscosity. This property allows the viscosity of the present resin composition containing such a phenolic resin to be decreased, such that the present resin composition still possess excellent flowability even when abundant inorganic fillers are used. Moreover, the bonding energy between phenyl rings of the skeleton of such a phenolic resin is high, therefore the present resin composition has stronger impact resistance and stress creak resistance after curing. When the present resin composition is applied to electronic products utilizing lead-free solder materials, remarkable heat resistance is remained under the processing conditions at high temperature.

In addition to the phenolic resin having a skeleton formed through direct bonding of phenyl rings, other known hardeners used in general epoxy resin compositions may also be applied to the present resin composition. Examples of the other hardeners include, but not limited to, polymers containing phenolic hydroxyl group, such as phenol type novolac resins, cresol type novolac resins, phenolic resins modified by cyclopentadiene, and copolymers thereof.

It is preferable that the amount of the phenolic resin having a skeleton formed through direct bonding of phenyl rings is in the range of 30 to 100% by weight based on the whole hardeners in the resin composition. If the amount of the phenolic resin is less than 30% by weight based on the whole hardeners in the resin composition, the resin composition can't reach UL 94 V-0 specifications for flame retardancy and its flowability can't be enhanced either.

The equivalent ratio of the epoxy resin to the phenolic resin hardener in the present resin composition is, based on the ratio of the epoxy equivalent of the epoxy resin to the active hydrogen equivalent of the phenolic resin hardener, 1:0.4 to 1:2.5; preferably 1:0.5 to 1:2.0; and more preferably 1:0.6 to 1:1.5.

The curing catalyst in the present resin composition refers to the compounds that can promote curing reaction between the epoxy groups of an epoxy resin and the active hydrogen-containing groups (e.g. hydroxyl group of phenol and the like) of a hardener. Examples of the curing catalyst include, but not limited to, tert-amines such as triethylamine, benzyldimethylamine and α-methylbenzyldimethylamine; tert-phosphines such as triphenylphosphine, tributylphosphine, tri(p-methylphenyl)phosphine and tri(nonylphenyl)phosphine; quarternary ammonium salts such as tetramethylammonium chloride, tetraethylammonium bromide, tetrabutylammonium iodide, triethylbenzylammonium chloride, triethylbenzylammonium bromide and triethylphenylethylammonium iodide; quarternary phosphonium salts such as tetrabutylphosphonium chloride, tetraphenylphosphonium bromide, ethyltriphenylphosphonium chloride, propyltriphenylphosphonium bromide, butyltriphenylphosphonium iodide, tetrabutylphosphonium acetate, and ethyltriphenylphosphonium phosphate; and imidazolyl compounds such as 2-methylimidazole, 2-heptadecylimidazole, 2-phenylimidazole, 4-ethylimidazole, 4-dodecylimidazole, 2-phenyl-4-hydroxylmethylimidazole, 2-ethyl-4-hydroxylmethylimidazole, 1-cyanoethyl-4-methylimidazole and 2-phenyl-4,5-dihydroxylmethylimidazole; and the like. Such curing catalyst can be used alone or in combination with two or more thereof. Imidazolyl compounds and quarternary phosphonium salts are preferable, particularly 2-methylimidazole, 2-phenylimidazole, ethyltriphenylphosphonium acetate, or mixtures thereof.

The curing catalyst is present in an amount which can effectively promote the curing reaction of resins. In one embodiment, the amount of the curing catalyst is, based on the whole resin composition, 0.01 to 5.0% by weight; preferably 0.02 to 3.0% by weight; and more preferably 0.05 to 2.0% by weight. If the curing catalyst is insufficient, the desired curability can't be obtained. On the other hand, if the curing catalyst is excessive, the flowability of the resin composition is adversely affected.

The resin composition of this invention may further comprise inorganic fillers to modify its properties such as electrical conductivity, abrdsion resistance, coefficient of thermal expansion, tensile strength, thermal conductivity, water resistance, chemical resistance, and the like. Examples of the inorganic filler include, but not limited to, silica such as fused silica, crystalline silica; quartz glass; talc; aluminium oxide, silicon nitride, aluminium nitride, titanium oxide, calcium carbonate, and the like. The type and amount of inorganic filler are not specifically restricted as long as they do not result in disadvantages. Generally, the inorganic fillers contained in the resin composition of this invention may amount to, based on the whole resin composition, 50 to 95% by weight; more preferably 70 to 90% by weight; and more preferably 80 to 90% by weight.

The present resin composition may also include additives, if necessary. The type is not particularly restricted, but it is preferable that the additives do not react with epoxy resins or hardeners. Examples of the additives include colorant such as carbon black; coupling agent such as γ-glycidoxypropyltrimethylsilane; releasing agent such as paraffin wax, higher fatty or its metal salts; antioxidant; and the like.

The resin composition of the present invention can perform excellent flame retardancy without adding any flame retardants, and has superior heat resistance. The present resin composition can still maintain remarkable flowability and moldability even if high amount of inorganic fillers is used. This resin composition can be applied to prepare composite materials, and can be used as forming materials or semiconductor packaging materials.

The character and efficacy of the present invention will be further described in details by referring to the following examples.

### EXAMPLES

The components used herein are described as follows:

### Epoxy resin 1: Cresol Novolac type epoxy resin CNE200 (Chang Chun Plastics Co., Ltd., epoxy equivalent 200-220 g/eq)

### Epoxy resin 2: Tetrabromo-bisphenol A diglycidyl ether BEB530A80 (Chang Chun Plastics Co., Ltd., epoxy equivalent 430-450 g/eq, bromine content 18.5-20.5 wt %)

### Epoxy resin 3: Epoxy resin NC3000P (Nippon Kayaku K. K., with the skeleton of biphenyl unit as represented by formula (I), epoxy equivalent 272 g/eq)

### Epoxy resin 4: Epoxy resin with the skeleton of naphthyl unit as represented by formula (II), wherein c is 0; d is 0; and q is an integer of 1 to 10, epoxy equivalent 270 g/eq.

### Hardener 1: o-Cresol resin represented as formula (III), active hydrogen equivalent 117 g/eq.

### Hardener 2: Novolac resin PF5080 (Chang Chun Plastics Co., Ltd., active hydrogen equivalent 105-110 g/eq)

### Catalyst (curing accelerator): Triphenylphosphine

The analytical methods used in this specification are as follows:

### (1) Spiral Flow

Spiral flow is measured at 175° C. and 70 kg/cm² in accordance with EMMI-1-66.

### (2) Flame Retardancy

A sheet of 5×0.5× 1/16 inch was tested in accordance with UL-94-V-0 vertical burning test specifications.

### (3) Hygroscopicity

A circle sheet of 25 (diameter)×5 (thickness) mm was cooked in hot water at 100° C. for 24 hr, and the amount of water adsorbed was measured.

### (4) Heat Resistance in Solder Bath at 288° C.

A sheet of 5×0.5× 1/16 inch was immersed in a solder bath at 288° C. for 30 seconds. It was observed whether bubbles or cracks were occurred on the surface of the sheet.

### Example 1-3, Comparative Example 1-3, and Reference Example 1

Each compositions according to Table 1 was sufficiently mixed at room temperature, and then compounded with a twin roller mixer at 70-110° C. After cooling, each mixture was crushed to give epoxy resin composition as powder. Spiral flow, flame retardancy, hygroscopicity, and heat resistance of each sample was examined. The results are shown in Table 1.

TABLE 1

| | | | | comparative | | | |
|---|---|---|---|---|---|---|---|
| component | examples | | | examples | | | reference |
| (wt %) | 1 | 2 | 3 | 1 | 2 | 3 | example 1 |
| epoxy resin 1 | | | | | 7.6 | 10.1 | 16.0 |
| epoxy resin 2 | | | | | | | 3.0 |
| epoxy resin 3 | 8.5 | 8.7 | | 9.7 | | | |
| epoxy resin 4 | | | 8.5 | | | | |
| Hardener 1 | 3.5 | 1.0 | 3.5 | 0.66 | 4.4 | 5.9 | |
| hardener 2 | | 2.3 | | 2.64 | | | 9 |
| triphenylphosphine | 0.15 | 0.15 | 0.15 | 0.15 | 0.15 | 0.15 | 0.15 |
| fused silica | 86 | 86 | 86 | 86 | 86 | 42 | 70 |
| aluminium hydroxide | | | | | | 40 | |
| releasing agent | 1 | 1 | 1 | 1 | 1 | 1 | 1 |
| coupling agent | 0.65 | 0.65 | 0.65 | 0.65 | 0.65 | 0.65 | 0.65 |
| carbon black | 0.2 | 0.2 | 0.2 | 0.2 | 0.2 | 0.2 | 0.2 |
| total amount | 100 | 100 | 100 | 100 | 100 | 100 | 100 |
| Equivalent ratio* | 1.03 | 1.05 | 1.03 | 1.04 | 1.07 | 1.00 | 1.03 |
| spiral flow(cm) | 77 | 60 | 63 | 55 | 50 | 62 | 85 |
| flame retardancy | ◯ | ◯ | ◯ | X | X | ◯ | ◯ |
| UL-94 V-0 | | | | | | | |
| hygroscopicity(%) | 0.21 | 0.22 | 0.19 | 0.21 | 0.23 | 0.25 | 0.27 |
| heat resistance in | ◯ | ◯ | ◯ | ◯ | ◯ | X | ◯ |
| solder bath at 288° C. | | | | | | | |

*equivalent ratio: epoxy equivalent of epoxy resin to active hydrogen equivalent of hardener.

As shown in Table 1, the resin compositions of examples 1-3, that use the epoxy resins with biphenyl unit or naphthyl unit and o-cresol resin with direct aromatic ring bonding skeleton (hardener 1), which is used as a hardener, have not only the same flame retardancy as the conventional epoxy resin containing bromine (reference example 1) to satisfy the UL 94 V-0 (thickness: 1.6 mm) requirement for flame retardancy, but also have good heat resistance, though the inorganic fillers amounted up to 86% by weight.

Further, if the amount of hardener 1 is less than 30% by weight of the total hardeners (comparative example 1) or the epoxy resin with biphenyl unit is substituted by the cresol Novolac type epoxy resin (comparative example 2), the test compositions can not reach the requirement of UL 94 V-0 specification for flame retardancy.

In the case of comparative example 3, the epoxy resin with biphenyl unit or naphthyl unit is replaced by aluminum hydroxide as a flame retardant. In this case, although it satisfied the requirement of UL 94 V-0, the bubbles were generated on the surface of the test sheet in solder bath at 288° C. This was due to the degradation of aluminum hydroxide to release water at 180° C. Therefore, the test composition failed to satisfy the requirement of heat resistance.

On the other hand, when compared with the comparative examples 2-3 using conventional Novolac resin (hardener 2) as the hardener, the compositions of the present invention, that uses o-cresol resin (hardener 1) in a specific amount as a hardener in examples 1-3 according to the present invention, have better flowability, and maintain good moldability even these compositions contain the inorganic fillers up to 86% by weight.

The foregoing examples merely illustrate the features and functions of the present invention and do not restrict the scope of the present invention. Modifications and variations may be made without departing from the spirit and principle of the present invention by those people skilled in the art. The scope of the present invention is defined by the appended claims.

What is claimed is:

1. A non-flammable retardative resin composition, comprising:
(A) at least an epoxy resin with biphenyl unit or naphthyl unit;
(B) at least a phenolic resin used as a hardener, wherein the phenolic resin has a skeleton formed by phenyl rings bonding directly with each other without interruption, and is contained in an amounts of 30 to 100% by weight based on total hardeners; and
(C) a curing catalyst.

2. The composition of claim 1, wherein the epoxy resin with biphenyl unit has a structure represented by formula (I): 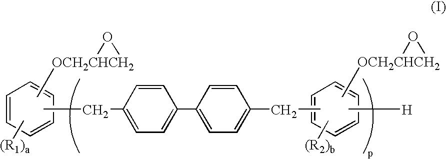
wherein, R₁ and R₂ each independently are alkyl group having 1 to 6 carbon atoms;
a is an integer of 0 to 4; b is an integer of 0 to 3; and p is an integer of 1 to 10.

3. The composition of claim 2, wherein, the alkyl group is selected from the group consisting of methyl, ethyl, propyl, isopropyl, butyl, sec-butyl, pentyl, cyclopentyl, hexyl, and cyclohexyl.

4. The composition of claim 1, wherein the epoxy resin with naphthyl unit has a structure represented by formula (II): 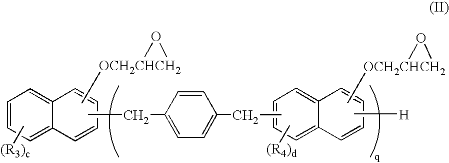
wherein, R₃, and R₄ each independently are alkyl group having 1 to 6 carbon atoms;
c is an integer of 0 to 6; d is an integer of 0 to 5; and q is an integer of 1 to 10.

5. The composition of claim 4, wherein, the alkyl group is selected from the group consisting of methyl, ethyl, propyl, isopropyl, butyl, sec-butyl, pentyl, cyclopentyl, hexyl, and cyclohexyl.

6. The composition of claim 1, wherein the phenolic resin has a structure represented by formula (III): 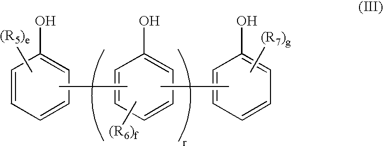
wherein, R₅, R₆, and R₇ each independently are alkyl group having 1 to 6 carbon atoms; e and g each independently are an integer of 0 to 4; f is an integer of 0 to 3;
and r is an integer of 1 to 10.

7. The composition of claim 6, wherein, the alkyl group is selected from the group consisting of methyl, ethyl, propyl, isopropyl, butyl, sec-butyl, pentyl, cyclopentyl, hexyl, and cyclohexyl.

8. The composition of claim 1, wherein, the ratio of the epoxy resin to the hardener is in the range of 1:0.4 to 1:2.5 based on the epoxy equivalent of the epoxy resin and the active hydrogen equivalent of the hardener.

9. The composition of claim 1, wherein, the ratio of the epoxy resin to the hardener is in the range of 1:0.5 to 1:2.0 based on the epoxy equivalent of the epoxy resin and the active hydrogen equivalent of the hardener.

10. The composition of claim 1, wherein, the ratio of the epoxy resin to the hardener is in the range of 1:0.6 to 1:1.5 based on the epoxy equivalent of the epoxy resin and the active hydrogen equivalent of the hardener.

11. The composition of claim 1, wherein, the curing catalyst is selected from the group consisting of tert-amines, tert-phosphines, quarternary ammonium salts, quarternary phosphonium salts and imidazolyl compounds.

12. The composition of claim 1, wherein, the curing catalyst is contained in an amount of 0.01 to 5.0% by weight based on the whole composition.

13. The composition of claim 1, wherein, the curing catalyst is contained in an amount of 0.02 to 3.0% by weight based on the whole composition.

14. The composition of claim 1, wherein the curing catalyst is contained in an amount of 0.05 to 2.0% by weight based on the whole composition.

15. The composition of claim 1, wherein, the composition further comprises inorganic fillers.

16. The composition of claim 15, wherein, the inorganic fillers are selected from the group consisting of fused silica, crystalline silica; quartz glass, talc, aluminum oxide and calcium carbonate.

17. The composition of claim 1, wherein, the composition further comprises additives.

18. The composition of claim 17, wherein, the additives are selected from the group consisting of colorants, coupling agents, release agents, and antioxidants.
